(19) United States
(12) Patent Application Publication
(10) Pub. No.: US 2026/0007958 A1
(43) Pub. Date: Jan. 8, 2026

(54) CONTROLLER PAD AND GAMING ASSEMBLY

(71) Applicant: QANBA USA, LLC, Daly City, CA (US)

(72) Inventors: Jeffrey LYO, Daly City, CA (US); Kai LIU, Daly City, CA (US); Xiang Long Zhong, Shenzhen (CN)

(21) Appl. No.: 19/258,849

(22) Filed: Jul. 2, 2025

(30) Foreign Application Priority Data
Jul. 3, 2024 (CN) 2024215682676

(51) Int. Cl. A63F 13/24; A63F 13/98

(52) U.S. Cl. CPC A63F 13/24; A63F 13/98

(57) ABSTRACT

The present disclosure discloses a controller pad and a gaming assembly for a gaming controller. The gaming controller includes a support area, a controller pad is arranged in the support area to support the contact part of a user, the controller pad includes a base in a preset shape and a contact member arranged on the base, the base and the contact member have different hardnesses, and the contact member is used to contact the contact part. Thus, the controller pad of the present disclosure can improve a user's operating experience as a whole.

### CROSS-REFERENCE TO RELATED APPLICATION(S)

The present application claims priority to and the benefit of Chinese Patent Application No. 2024215682676, filed at the China National Intellectual Property Administration on Jul. 3, 2024, the entire disclosure of which is incorporated herein by reference.

### TECHNICAL FIELD

The present disclosure relates to the field of game peripherals, and in particular to a controller pad and a gaming assembly.

### BACKGROUND

A support area of existing arcade gaming controllers is usually a flat transition between the gaming controller and the user (e.g., the user's elbow). If (e.g., when) a user plays games for a long period of time, their wrists tend to feel tired and numb.

### SUMMARY

An object of the present disclosure is to provide a controller pad that may enhance a user's operating experience. The controller pad may be adapted to a support area of a gaming controller and also support the user's hands and/or wrists.

The present disclosure achieves the above-mentioned object with the following technical solutions.

A first aspect of the present disclosure provides a controller pad for supporting a contact part of a user of a gaming controller. The controller pad may include a base in a 1 preset shape and a contact member arranged on the base, where the base and the contact member may have different hardnesses, and the contact member may be configured to contact the contact part of the user.

In one or more embodiments, the hardness of the base may be greater than the hardness of the contact member.

In one or more embodiments, a material of the base may be selected from among Polyethylene Terephthalate (PET), Polyvinyl Chloride (PVC), Polypropylene (PP), and Polystyrene (PS).

In one or more embodiments, a material of the contact member may be selected from among sponge, rubber, and fiber felt.

In one or more embodiments, a shape of the base may be adapted to a shape of the support area.

In one or more embodiments, a surface shape of the contact member may be adapted to the contact part.

In one or more embodiments, a plurality of protrusions may be provided on a surface of the contact member.

In one or more embodiments, a shape of a protrusion on a surface of the contact member may be selected from among a hemispherical shape, a cone shape, a polygonal prism shape, and an irregular shape.

In one or more embodiments, a surface of the contact member may be provided with stripes.

A second aspect of the present disclosure provides a gaming assembly. The gaming assembly may include a gaming controller and a controller pad. The controller pad may be arranged at a support area of the gaming controller to support a contact part of a user. The controller pad may include a base in a preset shape and a contact member arranged on the base, where the base and the contact member may have different hardnesses, and the contact member may be configured to contact the contact part of the user.

A third aspect of the present disclosure provides a gaming system. The gaming system may include a gaming assembly including a gaming controller and a controller pad. The controller pad may be arranged at a support area of the gaming controller to support a contact part of a user. The controller pad may include a base in a preset shape and a contact member arranged on the base, where the base and the contact member may have different hardnesses, and the contact member may be configured to contact the contact part of the user.

In the present disclosure, the base may contact the gaming controller, and the contact member may contact the contact part (e.g., hand and/or wrist) of a user. In addition, the base and the contact member may have different hardnesses. In this way, the controller pad of the present disclosure may improve a user's operating experience as a whole when operating the gaming controller.

The beneficial effect of the present disclosure may include providing the controller pad according to one or more embodiments of the present disclosure to improve a user's operating experience as a whole.

### BRIEF DESCRIPTION OF THE DRAWINGS

To more clearly illustrate the technical solutions in one or more embodiments of the present disclosure or the existing technology, the following will briefly introduce the drawings needed for the description of the embodiments or the existing technology. The drawings described below are only some embodiments of the present disclosure. For a person of ordinary skill in the art, other drawings can be obtained based on these drawings without creative efforts.

FIG. 1 is a front view of an example controller pad, according to one or more embodiments of the present disclosure.

FIG. 2 is a top view of an example controller pad, according to one or more embodiments of the present disclosure.

FIG. 3 is an overall structural diagram of an example gaming assembly, according to one or more embodiments of the present disclosure.

FIG. 4 is a side view of an example gaming assembly, according to one or more embodiments of the present disclosure.

1. controller pad; 2. gaming controller; 11. base; 12. contact member; 21. support area; 22. operation area; 23. function area

### DETAILED DESCRIPTION

In order to make the objects, technical solutions and advantages of the present disclosure clear, the technical solutions of the present disclosure will be described in detail below. The embodiments described herein are only part of the embodiments of the present disclosure, not all of them. Based on these embodiments of the present disclosure, all other embodiments or implementations obtained by a person of ordinary skill in the art without creative efforts should fall within the scope of protection of the present disclosure.

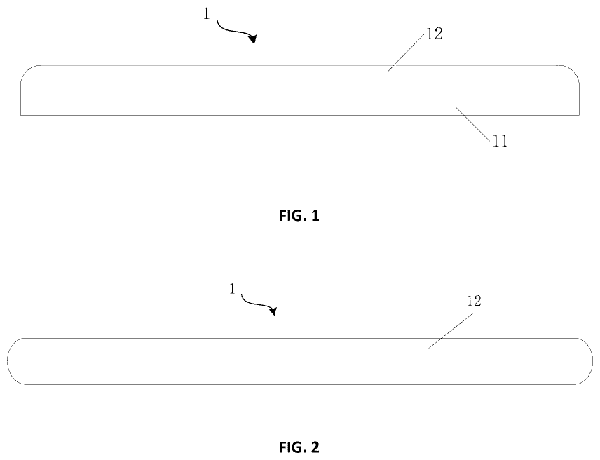

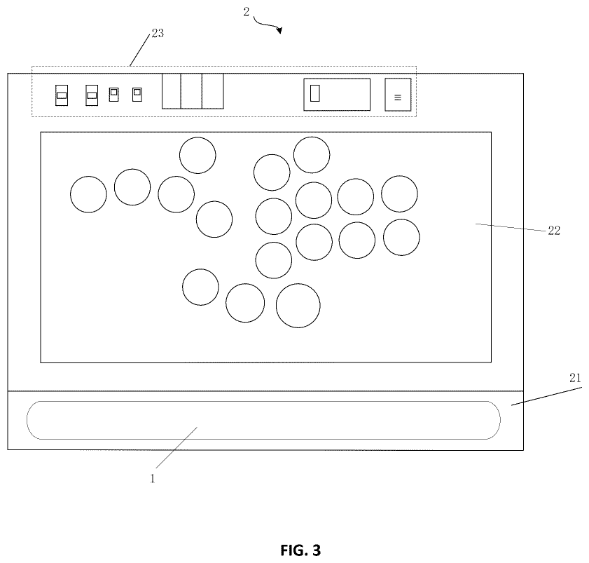

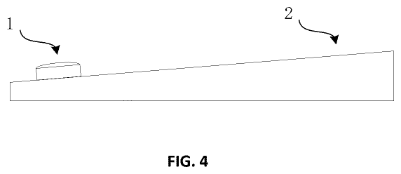

FIG. 1 is a front view of an example controller pad, according to one or more embodiments of the present disclosure. FIG. 2 is a top view of an example controller pad, according to one or more embodiments of the present disclosure. FIG. 3 is an overall structural diagram of an example gaming assembly, according to one or more embodiments of the present disclosure. FIG. 4 is a side view of an example gaming assembly, according to one or more embodiments of the present disclosure.

The first aspect of the present disclosure provides a controller pad 1 for a gaming controller 2. The gaming controller 2 may include a support area 21. In some embodiments, the controller pad 1 may be arranged at the support area 21 to support a contact part of a user. For example, the controller pad 1 may be a matching controller pad that may be adapted to the support area of the gaming controller 2 and also support the user's hands and/or wrists.

The controller pad 1 may include a base 11 and a contact member 12. In some embodiments, the base 11 may be configured to contact the gaming controller 2. For example, the base 11 of the controller pad 11 may be arranged in the support area 21 of the gaming controller 2. The contact member 12 of the controller pad 11 may contact a contact part of a user. For example, the contact member 12 of the controller 11 may be configured to support/contact a user's wrist and/or hand. In some embodiments, the base 11 and the contact member 12 may have different hardnesses. For example, the hardness of the base 11 may be greater than the hardness of the contact member 12, so that the contact member 12 is relatively soft to improve the support for the user's wrist and/or hand. In this way, the controller pad 1 of the present disclosure may improve the operating experience for the user as a whole when operating the gaming controller 2.

In some embodiments, the material of the base 11 may be selected from among Polyethylene Terephthalate (PET), Polyvinyl Chloride (PVC), Polypropylene (PP), and Polystyrene (PS).

In some embodiments, the material of the contact member 11 may be selected from among sponge, rubber, and fiber felt.

In some embodiments, the shape of the support area 21 may be adapted to the shape of the base 12. For example, if (e.g., when) the shape of the base is rectangular, the shape of the support area 21 may also be rectangular.

In some embodiments, the support area 21 may be provided with a recess for accommodating the base 12. For example, the support area 21 may include a housing that corresponds to a shape of the base 12, so that the base 12 may be properly placed or installed in the housing of the support area 21. Therefore, the base 12 of the controller pad 1 (or the entire controller pad 1) may be conveniently fixed to the support area 21 of the gaming controller 2.

In some embodiments, a surface shape of the contact member 11 may be adapted to the contact part of the user. For example, the contact part of a user usually is the user's hand or wrist, therefore, the surface shape of the contact member 11 may be designed to have a curvy surface (e.g., an arc structure) that matches the user's hand or wrist. In this way, the comfort for the user's hand or wrist may be improved.

In some embodiments, the surface of the contact member 11 may be provided with a plurality of protrusions.

In some embodiments, the shape of the protrusion may be selected from among a hemispherical shape, a cone shape, a polygonal prism shape, and an irregular shape.

In some embodiments, the contact member 11 may be provided with stripes on its surface. Thus, the stripes may provide a massaging effect on the user (e.g., the contact part of the user, such as the user's hand or wrist). In some embodiments, the stripes may match the surface stripes of the gaming controller 2, which may enhance the overall aesthetics of the controller pad 1 and the gaming controller 2.

The second aspect of the present disclosure provides a gaming assembly. The gaming assembly may include the gaming controller 2 and the controller pad 1 according to one or more embodiments discussed in the first aspect. The gaming controller 2 may include a support area 21, and the controller pad 1 may be arranged in the support area 21 to support the contact part of a user.

In some embodiments, the gaming controller 2 may further include an operation area 22 and a function area 23. In some embodiments, the operation area 22 may be provided with a plurality of switches for a user to operate. In some embodiments, the function area 23 may be provided with a plurality of physical switches, such as a light indicator switch, an exchange switch, and/or the like.

Referring to FIG. 4, the side view of the gaming controller 2 of the present disclosure may be a trapezoidal structure. In this case, the controller pad 1 may be arranged on a lower side of the gaming controller 2. Therefore, the controller pad 1 may support the user's hand or wrist by raising the hand or wrist to avoid the drowsiness or numbness caused by long operating hours.

The beneficial effect of the present disclosure may include providing the controller pad 1 of the present disclosure to improve a user's operating experience as a whole.

The above are merely some specific embodiments of the present disclosure, but the scope of protection of the present disclosure is not limited thereto. A person skilled in the art can easily think of changes or substitutions within the technical scope disclosed in the present disclosure, which should be covered within the scope of protection of the present disclosure. Therefore, the scope of protection of the present disclosure shall be determined by the scope of protection of the claims and equivalents thereof.

What is claimed is:

1. A controller pad for supporting a contact part of a user of a gaming controller, the controller pad comprising:
a base in a preset shape and a contact member arranged on the base,
wherein the base and the contact member have different hardnesses, and
wherein the contact member is configured to contact the contact part of the user.

2. The controller pad of claim 1, wherein the hardness of the base is greater than the hardness of the contact member.

3. The controller pad of claim 1, wherein a material of the base is selected from among Polyethylene Terephthalate (PET), Polyvinyl Chloride (PVC), Polypropylene (PP), and Polystyrene (PS).

4. The controller pad of claim 1, wherein a material of the contact member is selected from among sponge, rubber, and fiber felt.

5. The controller pad of claim 1, wherein a shape of the base of the controller pad is adapted to a shape of a support area of the gaming controller.

6. The controller pad of claim 1, wherein a surface shape of the contact member is adapted to the contact part.

7. The controller pad of claim 1, wherein a plurality of protrusions is provided on a surface of the contact member.

8. The controller pad of claim 1, wherein a shape of a protrusion on a surface of the contact member is selected from among a hemispherical shape, a cone shape, a polygonal prism shape, and an irregular shape.

9. The controller pad of claim 1, wherein a surface of the contact member is provided with stripes.

10. A gaming assembly comprising a gaming controller and a controller pad, wherein:
the controller pad is arranged at a support area of the gaming controller to support a contact part of a user,
the controller pad comprises a base in a preset shape and a contact member arranged on the base, wherein the base and the contact member have different hardnesses, and the contact member is configured to contact the contact part of the user.

11. The gaming assembly of claim 10, wherein the hardness of the base is greater than the hardness of the contact member.

12. The gaming assembly of claim 10, wherein a material of the base is selected from among Polyethylene Terephthalate (PET), Polyvinyl Chloride (PVC), Polypropylene (PP), and Polystyrene (PS).

13. The gaming assembly of claim 10, wherein a material of the contact member is selected from among sponge, rubber, and fiber felt.

14. The gaming assembly of claim 10, wherein a shape of the base is adapted to a shape of the support area.

15. The gaming assembly of claim 10, wherein a surface shape of the contact member is adapted to the contact part.

16. The gaming assembly of claim 10, wherein a plurality of protrusions is provided on a surface of the contact member.

17. The gaming assembly of claim 10, wherein a shape of a protrusion on a surface of the contact member is selected from among a hemispherical shape, a cone shape, a polygonal prism shape, and an irregular shape.

18. The gaming assembly of claim 10, wherein a surface of the contact member is provided with stripes.

19. A gaming system comprising a gaming assembly, wherein the gaming assembly comprises a gaming controller and a controller pad, wherein:
the controller pad is arranged at a support area of the gaming controller to support a contact part of a user,
the controller pad comprises a base in a preset shape and a contact member arranged on the base, wherein the base and the contact member have different hardnesses, and the contact member is configured to contact the contact part of the user.

20. The system of claim 19, wherein the hardness of the base is greater than the hardness of the contact member.
